(19) United States
(12) Patent Application Publication
(10) Pub. No.: US 2007/0005151 A1
(43) Pub. Date: Jan. 4, 2007

(54) Note creation software

(75) Inventor: David Alan Burton, Raleigh, NC (US)

Correspondence Address: THE ECLIPSE GROUP, 10605 BALBOA BLVD., SUITE 300, GRANADA HILLS, CA, 91344, US

(73) Assignee: EasyNotes, LLC, Raleigh, NC (US)

(21) Appl. No.: 11/515,671

(22) Filed: Sep. 5, 2006

Related U.S. Application Data
(63) Continuation of application No. 11/082,343, filed on Mar. 17, 2005.
(60) Provisional application No. 60/553,843, filed on Mar. 17, 2004.

(51) Int. Cl. G05B 15/00

(52) U.S. Cl. 700/1

(57) ABSTRACT

The present invention is directed to computer software for the creation and maintenance of easily accessed tools to create notes regarding certain types of observations or transactions in a highly efficient and reliable way. The notes can be stored for subsequent access. In one disclosed implementation, the note creation templates are accessed via a toolbar. This aggregation of note creation templates can be modified by an end user observer and saved. The individual note creation templates can be modified by an end user observer and stored.

This document claims priority to U.S. patent application Ser. No. 11/082,343 filed Mar. 17, 2005 and its priority document, U.S. Provisional Patent Application No. 60/553,843 filed Mar. 17, 2004, and incorporates both applications including all appendixes by reference.

### BACKGROUND OF THE INVENTION

1. Field of the Invention

This document claims priority to U.S. patent application Ser. No. 11/082,343 filed Mar. 17, 2005 and its priority document, U.S. Provisional Application 60/553,843 filed Mar. 17, 2004 and incorporates both applications including all appendixes by reference. U.S. patent application Ser. No. 11/082,343 highlights the ability to integrate the note creation software with existing third party software. The present application uses an example where the note creation software works in collaboration with a separate set of note management software but highlights the innovative improvements to the process of creating notes for subsequent storage.

2. Related Art

Computer software applications to record data to create a permanent record of an event or an interaction are well known. Such software typically includes some sort of unique identifier for the entity of interest (usually the subject or object of the interaction). One class of examples of entities of interest is patients of medical providers (e.g. dentists, doctors, veterinarians . . . ) where the medical service provider wishes to record information about a particular transaction such as a visit from the patient. In addition to storing certain general fields with each transaction such as the patient's temperature, weight, and insurance information, there is often a desire to record specific types of information that varies from transaction to transaction. A generalist that sees a patient with high blood pressure and then sees one for a wart on the patients thumb will need to record different types of facts (blood pressure and possibly level of agitation for the high blood pressure patient but location, size, and nature of wart for the wart patient).

When the range of events to record is extremely high, then free form text fields provide an adequate solution as this emulates the traditional form of taking notes with paper and pencil. At the other end of the spectrum, if the range of events to record is very narrow such as a nurse gathering required information before giving a flu shot, then a highly formatted form that asks for specific information in a specific order is appropriate. If there is likely to be sufficient volume of this particular transaction, then the provider of the software application will add such a form as an input screen, or the management of the medical provider organization will see that the long term benefits of having such an input screen justify the expense of asking for a programmer to modify the software application to include such a screen.

What has not been well addressed is the intermediate case of frequent but not uniform needs to record certain types of information along with context providing text into a transaction note. Thus, the prior art has not adequately addressed the needs of those who frequently gather and input the same type of information in clusters. For example, a dermatologist may not record information about a wart with every patient visit, but will likely do so several times a week if not several times a day. Automating or semi-automating the process of recording notes about a patient with a wart would only expedite a small percentage of the dermatologist's transactions as the dermatologist has a number of situations that are frequently part of her practice.

Problems with the Prior Art Options

A) Pen on Paper Method

One option is to write notes and have these added to a paper file. This option has the following disadvantages: 1) Time consuming; 2)Difficult to read and understand later; 3) Cumbersome and messy; 4) Need space to store all of the charts (and space is expensive); 5) Employees must spend time filing and there is the risk that some notes may not adequately identify the patient or session and thus be lost or misfiled; 6) the entire chart can be lost and would not have an electronic backup; 7) Not very HIPPA compliant; and 8) paper notes can not be searched electronically. The HIPPA point merits some amplification. HIPPA is the Health Information Privacy Protection Act which restricts access to medical information to those with a need to access the information. Paper notes pose HIPPA problems as the physical note (even those created through the use of a computer program then printed) is susceptible to being read by those without a need to do so as the note is created, possibly photocopied, placed in a bin for filing, and eventually filed. In contrast a note in a computerized document that stays in computer memory (and is not printed for filing) can be safeguarded from authorized access.

B) Using a Keyboard to Type Notes

A second option is to use a keyboard to type the notes into the textbox of the clinical notes program. The disadvantages are that 1) Not everyone knows how to type; 2) Extremely time consuming and slow (for example: A hygienist can take as much as 7 minutes or more to type her notes for a single patient session); and 3) Presents problem with infection control as the clinician must move both hands onto the keyboard while working with the patient thus increasing the risk of cross patient contamination. With respect to cross contamination, the risk is there with most input devices but a mouse or light pen can be used with a protective cover that is switched between patients. It is difficult to use a keyboard with a protective cover and the nature of most keyboards is that the keyboards have small moving parts with many nooks and crannies that are difficult to clean, especially since cleaning liquids can damage some keyboards.

C) Transcribing Dictated Notes

Another option is to use a dictation machine and have the notes transcribed afterwards. This method has the following disadvantages: 1) Requires investment in dictation hardware; 2) Expensive to pay transcriptionists; 3) Delay in obtaining final documents; 4) Time consuming, sometimes the time with the patient can be expedited by waiting to dictate at the end of the day but this requires staying after work to dictate your notes; 5) Creating paper transcriptions raises the same issues discussed above with paper notes and charts; and 6) Also posed potential HIPPA compliance issues as the transcribed note must be physically routed from person to person in the office.

D) Auto-Note

The prior art includes a concept known as an auto-note. These prior art notes were mapped with one note per procedure code within the clinical software. As a procedure is marked as completed, an auto-note memorializing the administration of the procedure is added to the clinical notes in lieu of just putting the procedure code. This is in contrast with the notes possible under the present invention which allow for the partial automation of what are sometimes called SOAP notes (Subjective, Objective, Assessment & Plan). The details in SOAP notes vary from patient to patient and this is where relevant facts and decisions can be captured in notes so that the notes convey why the patient was seeking treatment (such as the symptoms) and other patient comments, the diagnosis, and details of the treatment plan including proposed actions for after this clinical session.

As with most clinical notes, a system with auto-note will allow the clinician to access the note and edit it. Thus, it would be possible to augment information about the procedures performed with additional information about why the patient was seeking treatment, the diagnosis, treatment alternatives, and future action items just as it would be with a system that required the clinician to key in all the information without any assistance from auto-note. As with any keyboard intensive solution, there are potential problems with infection control

E) Voice Recognition

A clinical notes program that uses voice recognition is another potential solution but this solution has the following disadvantage 1) Problems with voice recognition software leads clinicians to conclude that the software doesn't work, or at best it is unreliable as it only works “sometimes”; 2) Cumbersome wearing a voice recognition headset along with glasses and masks; 3) Requires a lot of talking and a lot of training; 4) Expensive investment; 5) Doesn't work with noisy backgrounds; 6) Clinician can be easily interrupted by staff and lose train of thought; 7) Presents problems with office turnover, must retrain with new voices of new employees; and 8) Patients can hear what you are saying about them if you are dictating notes in the operatory; problem is compounded with open office layouts which allow the clinician such as a dentist to move between patients in a large open room.

Thus, there is a need for a tool to partially automate and preferably customize the collection of facts and the creation of notes for inserting in the pre-existing software applications that contain text fields for entry of such information.

Portions of the present application address deficits in the prior art and one or more of the following objectives:
To save the observer's time by partially automating the task of writing the notes concerning a specific class of event or transaction.
To give the observer the ability to customize a sequence questions to be addressed in a specific note or portion of a note.
To enable the observer to customize the content of prompts used to obtain information used in the semi-automated notes.
To enable the observer to customize the selection and sequence of prompts used to obtain information used in the semi-automated notes.
To enable the observer to create note text templates that combine standard reporting phrases “binder text” and values collected from the end user observer to allow the observer to create and populate a note from a template thus saving time and keystrokes each time the observer wishes to create a formatted note of that type.
To increase the speed and accuracy of note creation to allow the observer to record observations about a transaction, thus reducing the incentive to accept the disadvantages of dictation to capture information.
To allow an observer to create, maintain, and modify a library of note creation templates comprising one or more input question and a text strings.
To allow the observer to create, maintain, and modify the library of note creation templates without having to obtain the services of an application programmer.
To allow each observer to tailor an initial set of note creation templates to the observer's specific needs and style thus avoiding the “cookie cutter” inherent in commercial application software that attempts to meet the needs of many somewhat similarly situated observers.
To allow the answers input by the observer to be saved in memory pending completion of the sequence of questions for that particular note creation template so that a coherent note can be created at the completion of the questions sequence and stored for subsequent access.
To increase the efficiency of note writing processes by allowing question sequences that are apt to be used again and again by the observer to be converted into a note creation template and thus saving the observer from the drudgery of typing the same text over and over again.
These and other advantages of the present invention are apparent from the drawings and the detailed description that follows. The above-referenced advantages may be achieved individually and/or in combination, and it is not intended that the present invention be construed as requiring two or more of the advantages to be combined unless expressly required by the claims attached that follow.

### SUMMARY

The present invention is directed to computer software for a note creation that satisfies the need to facilitate the creation and maintenance of easily accessed tools to create notes regarding certain types of observations or transactions in a highly efficient and reliable way. The note creation tools can be edited by the end user observer and the changes saved. Thus, over time, the tool sets available to an individual user can be tailored to match the preferences of that user. Likewise, specialized collections of tools can be aggregated and saved to serve the specific needs of a particular class of users. Thus, the primary collection of tools for use by hygienists in a dental practice can be set up differently than the primary set of tools for use by dentists in that same practice as the set of note creation templates used most often by hygienists may be different that the set of note creation templates used most often by dentists.

Selection of a note creation template for a dynamic note initiates a sequence of queries to obtain the relevant facts for a particular type of observation or transaction and then assembles a note formatted to include the facts and binder text that provides context. This note can be associated with a particular transaction (such as a clinical visit by a particular patient) and stored for later access.

Selecting a note creation template for a static note causes a text string without variables to be created. Again, this note can be associated with a particular transaction (such as a clinical visit by a particular patient) and stored for later access.

An example of a static note is the documentation that a particular instruction or warning was given from a health care provider to a patient. In one implementation of the inventive concepts, the end user of the note creation software can manipulate the aggregated tool set of note creation templates as well as the individual note creation templates for the static or dynamic notes.

The present invention can be implemented in a variety of ways. One commercial product is a software program known as Easy Notes Pro is noted to have the following advantages over the other options open to dentists. The advantages are summarized here but are put into context by the detailed description that follows.

A) Extremely fast at writing clinical notes.

B) In many situations the notes can be sufficiently customized so that the system can be operated without typing after initial setup and customization.

C) Contemporaneously captures and writes detailed explicit clinical notes that capture important information or milestones from start to finish of patient's visit, not just when a procedure is completed.

D) Requires very little investment (because it is an add-on and not a replacement to the clinical notes software).

E) Does not requires special voice recognition hardware, many dental clinical workstations already use a light pen and virtually all computers have some sort of x-y navigation tool (mouse, tablet computer pen, digitizer, et cetera).

F) Allows complete customization of the note text and dialog boxes by the end user without having to pay for a programmer to make the modifications. Different clinicians in the same office have the ability to modify and store note creation templates containing both the form of the note and the information input sequence to create the note.

G) Reduces HIPPA compliance issues as the note system does not have to generate paper notes, which need to be handled and eventually stored.

H) Decreases risk of cross contamination as there is zero to minimal use of the keyboard after the toolbar has been customized and the notes are adapted to capture the information deemed necessary to document actions in a particular practice. Input devices such as computer mouse, digitizer pad, touch screen, and light pens are easier to keep clean—especially for small devices that can be used within protective covers that can be swapped out for each patient.

I) Lowers risk management by providing improved detailed and legible notes (including legal defense, as the use of reminder boxes in the note creation process forces the clinician to acknowledge giving a set of specific instructions to the patient, asking a patient for certain information, or simply reminding the clinician to do or check something before proceeding).

J) Versatile. Systems in accordance with the present invention can be used by entire office without special training and the system allows the merger of the clinical and the administrative parts of the practice as it supports the insertion of administrative notes into the record such as failing to show for an appointment or a treatment plan selection made during a conference away from the operatory.

K) It works without the problems of voice recognition software, and the pre-scripted notes would be better than voice recognition where you are trying to think of what to say, pausing, then adding to the note, pausing, being interrupted by staff, pausing, again and again.

L) Avoids need for clinician to repeatedly provide the same boilerplate text such as would be required with other modes of input such as voice recognition.

M) The program is multi-tasking between operatories (each person's own toolbar) and multi-tasking within a multi-person practice. The customized toolbars can be customized to the liking of each person or customized for each practice so that every hygienist may use a different toolbar or a standardized toolbar can be created for use by all hygienists within a practice. The toolbars can be stored locally at each workstation (which may improved the response time) or accessed across a network from a central repository.

N) The notes generated with what appears to be typed text are easily read, which is not true of many clinician's handwritten notes.

### BRIEF DESCRIPTION OF THE FIGURES

FIG. 1 is a representation of the various components of a computer in accordance with the prior art.

FIG. 2 shows the environment for the present invention with observer 204 recording clusters of facts for certain types of transactions in a computer 100.

FIG. 3 shows a screen shot of both the clinical notes program 304 and the linked toolbar 308 from the note creation software.

FIG. 4 shows one step in the creation of a particular note using the note creation software, more specifically a dialog box to receive input on the specific tooth being discussed.

FIG. 5 shows a dynamic note 504 placed in a textbox of the clinical notes program 304.

FIG. 6 shows the process of opting to edit the process that created the dynamic note shown in FIG. 5.

FIG. 7 shows the edit step for editing the process that lead to the creation of the note shown in FIG. 5.

FIG. 8 shows three dialog boxes used to receive input used in the process to create a note regarding tooth decay.

FIG. 9 shows the screen display after the modification of the order of appearance of the first two dialog boxes.

FIG. 10 shows a screen display scrolled to the right to show a portion of the second dialog box and the two reminder dialog boxes (812 and 1004).

FIG. 11 shows a static note 1104 inserted into a textbox for the clinical notes software.

### DETAILED DESCRIPTION

The present invention will now be described more fully hereinafter with reference to the accompanying drawings, in which examples of the invention are shown. This invention may, however, be implemented in many different forms and should not be construed as limited to the examples rather, these examples are provided so that this disclosure will be thorough and complete, and will fully convey the scope of the invention to those skilled in the art. Like numbers refer to like elements throughout.

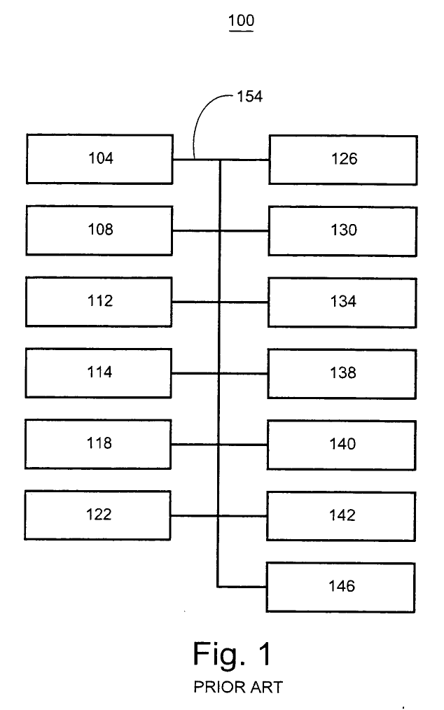

Computer systems such as personal computers are known in the art can be represented generically by FIG. 1. Such a system 100 will comprise a number of separate pieces but can be diagrammed as follows:

104 is an I/O Controller. An Input Output Controller works with the CPU for handling certain aspects of interactions with input/output devices.

108 is a DMA controller to allow direct communication between certain peripherals and RAM.

112 is the Central Processor Unit (CPU or Microprocessor). The CPU executes instructions and manipulates data.

114 is the Clock. The clock provides the one or more clock signals used by other components.

118 is the RAM (Random Access Memory) which is used for temporary memory when executing software.

122 is the ROM (Read Only Memory) which contains permanent memory such as start up instructions for the CPU.

126 is a Mass Storage Device. Most computers have one or more mass storage devices such as hard drives that store programs and data.

130 is a Media Drive. Most computers have one or more media drives such as CD drives or disc drives which can read programs and data from removable media. Many of these drives can also write to removable media.

134 is a Display. Most computers have one or more displays that provide a means for displaying text or graphics.

138 is an Input Device. Most computers have one or more input devices such as keyboards, computer mouse, touch pad, touch screen, light pen, digitizer tablet, or joy stick. Most computers have more than one input device such as a keyboard and a mouse.

140 is an Input Buffer which receives the input from the input device and holds it for subsequent access by the operating system or computer application programs operating on the computer or in data communication with the computer.

142 is a Network Connection. Many computers have one or more network connections. The network connection may include a specialized card such as a NIC card (network interface card), or a wireless card to enable a particular type of wireless connection such as Bluetooth or one of the versions of 802.11.

146 is a Printer. Most computers have some access to a printer or other output device that produces output on paper. These include printers, plotters, and bar code printers. Some computers access printers through the network connection.

154 represents the buses. The various components in the computer are connected by a set of buses that carry data, control signals, and addresses. As the subject matter of this patent does not involve an improvement to computer buses, the buses are shown in an over simplified manner to avoid unnecessary clutter.

Those of ordinary skill in the art will recognize that FIG. 1 does not capture all of the subcomponents necessary to operate a computer 100 (no power supply for example). FIG. 1 does not show all possible variations of computers as certain elements can be combined together such as combining the clock and the CPU. Further, a computer may have more elements than are shown in FIG. 1 including multiple instances of components shown in FIG. 1 and additional elements not shown in FIG. 1. Finally a computer can be configured to be lacking one or more elements shown in FIG. 1. For example a computer can be configured to operate without a DMA controller, or some elements of the computer of FIG. 1 can be removed from the computer, especially if it has access to such components through a network connection.

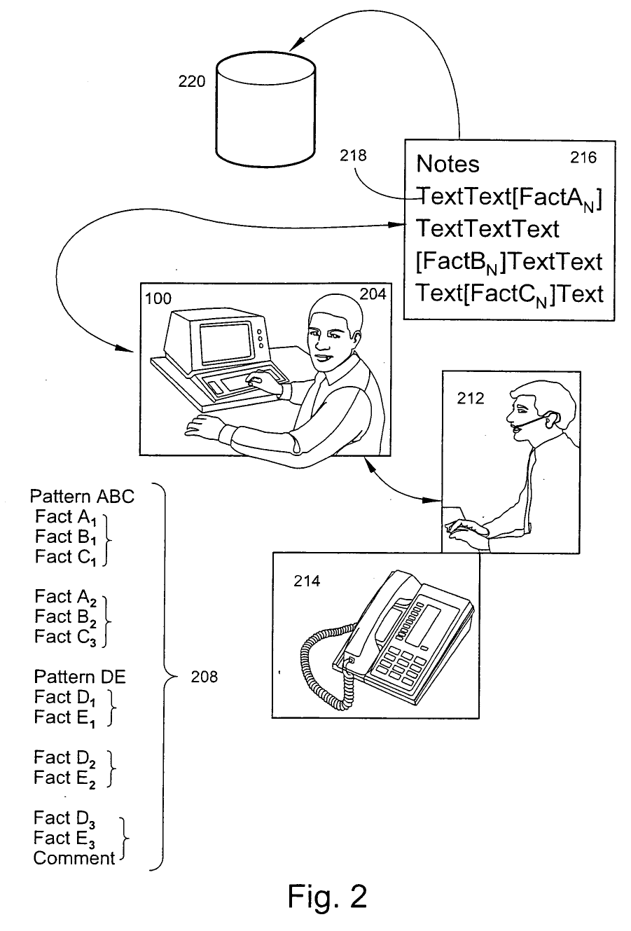

FIG. 2 illustrates the environment of the problem addressed by the present invention. Observer 204 collects information on relevant sets of facts 208 either through direct observation or through a chain of one or more reporters 212. These facts can be input to a computer program operating on the computer 100 through one or more input means such as a keyboard, mouse, microphone connected to a voice recognition software module; touch screen, or other input means known in the art.

A set of related facts will be joined by text strings to form a text note 216. This text note 216 is stored in memory 220 which may be in the computer 100, on suitable media which can be read by computer 100, or remote from the computer 100 but in data communication with the computer through any one of the means known in the art.

As this process is repeated with additional clusters of related facts, the observer is obligated to input virtually the same binder text 218 in note after note to tie together the entered facts and to provide context to the patient-specific facts. This process has several unfortunate consequences. Especially when viewed in the context that frequently, the observer 204 is highly trained and highly compensated so it is particularly desirable to minimize the amount of time consuming and repetitive tasks performed by this observer in order to better utilize the specialized skills and training of the observer.

At bare minimum, the observer 204 is spending a large amount of time in repeatedly typing binder text 218 and inserting the relevant facts. The observer 204 may attempt to reduce the amount of text entered for each cluster of facts by using the observer's own idiosyncratic abbreviations for the text necessary to provide context to the set of facts. These abbreviations may not be standardized across similarly situated observers that all provide notes 216 to the memory 220 such that it is difficult for those who subsequently retrieve the notes 216 to quickly review the notes as the format and abbreviations vary from note to note.

As the number of repetitions of fact gathering and note producing increase, it becomes more likely that some of the notes will fail to contain or accurately convey one or more facts in the relevant fact cluster. This problem of partially incomplete notes can be more common when the observer 204 is working with another party 212 which may interject facts out of sequence, or when the observer is interrupted or otherwise distracted by extraneous stimulus such as a ringing phone 214.

One prior art solution was the preparation of a form to receive a specific pattern of facts for particular context. Thus the use of the form and the structured input fields provide context for the information. These input forms while well adapted to certain transactions with a set of ten or more facts (such as a new patient form at a doctor's office) are not adequate for use in conjunction with application software designed to collect unformatted notes. These notes fields allow observations to be entered with relevant information for review at a later date. The aggregate collection of notes for a given subject (study, patient, machine, etc.) may include a number of clusters of facts of a first pattern, some clusters of facts of a second pattern, and a number of instances of a cluster of facts yet another pattern. The aggregate collection of notes may include additional non-standard observations and commentary to elaborate on the facts in a more common fact cluster.

The creation of a large number of forms, each optimized to collect a short sequence of facts is not the best situation in some contexts as the time needed to locate, load, and then specially move the form to storage may outweigh the savings from the use of the context providing form.

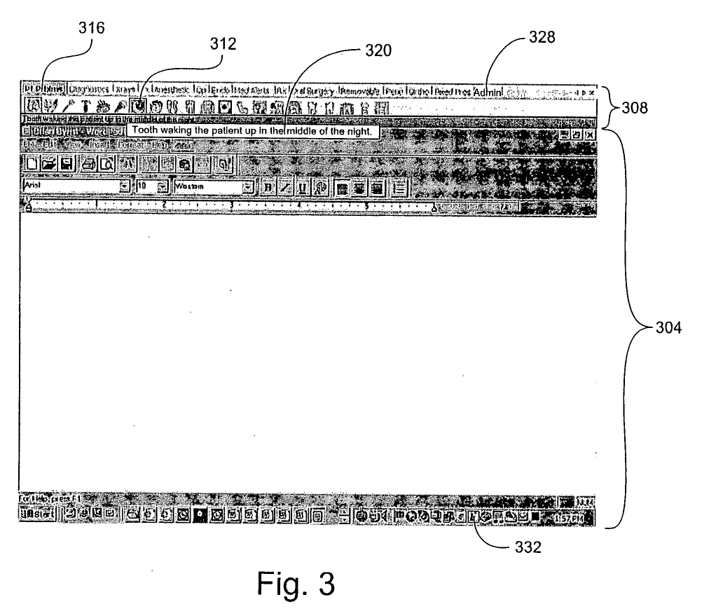

The present invention can be illustrated by a sequence of transactions for one particular observer Ann. For this particular example, Ann is a dentist that wishes to record facts and events from patient interactions into clinical software that Ann has loaded on her computer 100. Screen shots demonstrating some of the steps taken by Ann are provided in FIGS. 3-11. (Additional context can be acquired by viewing help files for one particular implementation of the present invention for use with a particular clinical note program instead of the more basic Word Pad program. These help files appear in Appendix A. Note the Patent and Trademark Office typically does not publish the Appendix material but it is available from the Patent and Trademark Office in connection with the prosecution history of this application.)

In this particular example, the tools for facilitating note creation are contained in a note creation software that can be used to facilitate the creation of notes that are ultimately stored via another set of computer software code running on the same computer system. Ann loads a note creation program on her computer and links this software to her clinical software package. The linkage of the note creation program to the clinical note program is done through conventional means and preferably without having to modify any of the program files for the clinical note program. An example of a satisfactory strategy for making the linkage can be found in prior art software SmartPad for Microsoft® Windows™ (Release 3.5) by Softblox, Incorporated of Atlanta, Ga. or by Aimstools by Aimsoft Development Corporation of Carson City Nev. (http://www.aimsoft.com/aimtools.html). In this particular example, the various note creation tools are arranged in a “toolbar” so that the navigation to the note creation tools is through tabs and buttons. Ann chooses to have the toolbar from the note creation software open and accessible each time she opens the clinical note program. (See Section A of the Appendix for one particular implementation of Linking a Toolbar to an application).

In one implementation of aspects of the invention, the note creation software program contains several sets of note creation tools created with different clinical focus. For example in the dental setting there may be a toolbar designed to record notes from a hygienist and a toolbar designed to record notes from a dentist since the range of notes that a hygienist would enter may be less than that of a dentist.

In one implementation, the selected toolbar from the note creation software code is copied into storage such as the computer's mass storage device 126 so that the copy of the toolbar can be customized without altering the basic toolbar provided with the note creation software program. In a practice with more than one dentist, each dentist could store one or more copies of the dentist toolbar, which could be customized by each dentist. An individual dentist could actually have more than one sets of note creation tools so that a particular set of note creation tools could evolve to be particularly convenient for use with pediatric patients and another particular set of note creation tools for adult patients.

A preferred process for linking note creation software to the underlying clinical records program is to drag a “target” to the particular window of the clinical notes program that will receive the output of the note creation software. This eliminates the need for the end user to know the name of that particular window. Typically, the link would be ongoing so that every time that particular window is opened in that clinical notes program the note creation software would be opened and display the user interface for accessing that particular set of note creation templates.

Ann goes to lunch and closes both the note creation software and the clinical notes software. Turning now to FIG. 3, after lunch Ann reopens the clinical note program 304 and the linked toolbar 308 from the note creation software also opens. The toolbar from the note creation software is placed adjacent but outside of the region of the display allocated to the clinical note program. To provide context without getting distracted with the details of a feature rich clinical notes package, assume Ann uses WordPad by Microsoft to collect her notes for each patient.

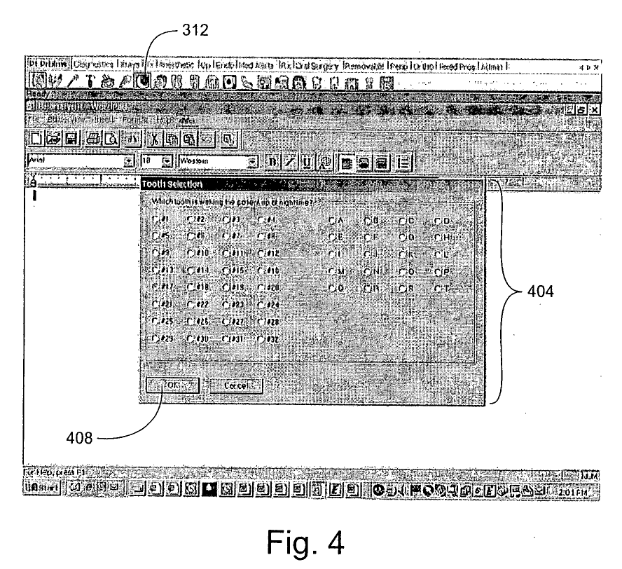

After talking with patient Brian Byrnt, Ann moves her cursor over a button 312 associated with the first tab 316 to obtain a reminder 320 of the context for the note that would be prepared by the routine associated with that particular button. In this case the button 312 handles a note for “tooth waking patient up in the middle of the night”. After actuating button 312, a screen shown in FIG. 4 is presented. Through use of a dialog box 404, Ann indicates that it is tooth 17 that is causing the problem and hits the OK button 408.

After actuating the OK button 408, this implementation of the note creation software having all the information needed for this simple dynamic note provides the note to the keyboard buffer maintained by the operating system. In one implementation, the note creation software yields the focus of the active window to the clinical note program before passing the dynamic note to the keyboard buffer. By the act of the operating system changing the active window to the clinical note program then the operating system sends the symbols received in the keyboard input buffer to the clinical note program as the normal operation is to pass the keyboard input to the active window.

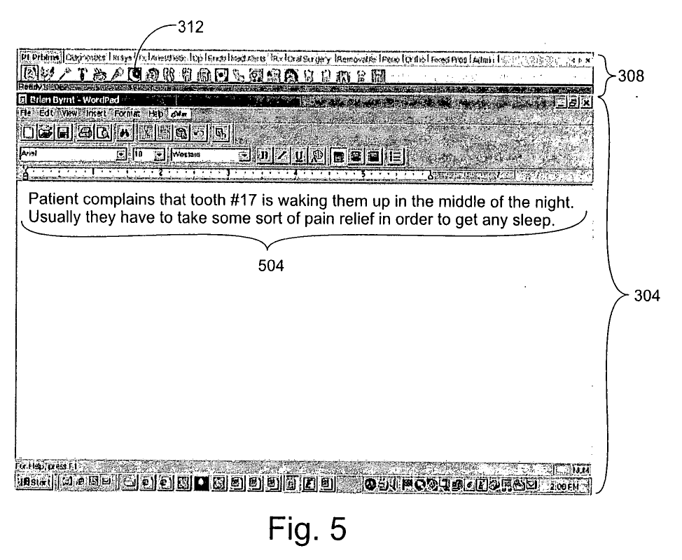

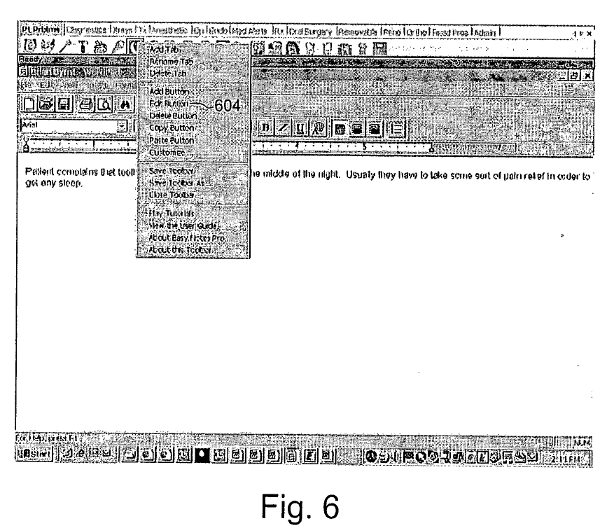

The resulting note 504 appears as shown in FIG. 5. Ann looks at the note and decides that she is not happy with referring to the single patient as a “they”. While she could edit the note now that it is in the clinical note program, Ann moves to edit the content of this binder text by right clicking on the night pain button 312 and selecting the Edit Button choice 604 as shown in FIG. 6.

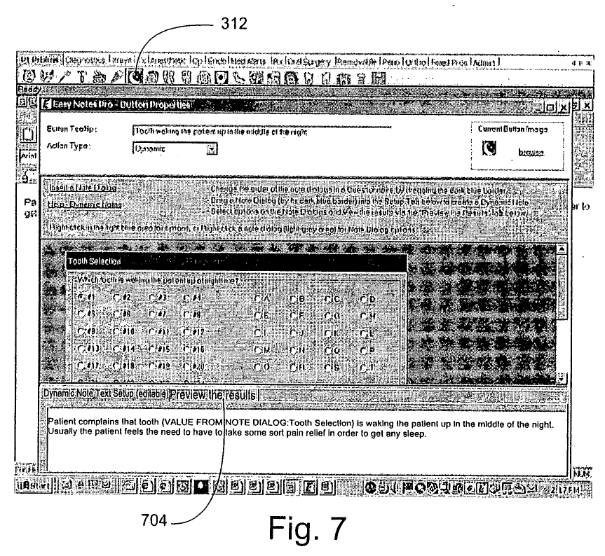

Ann is presented with the properties and the binder text used to provide context to the note as shown in FIG. 7. Ann revised the text including replacing “they” with “the patient”. By actuating the preview button 704, Ann may view the edited dynamic note text to see how the note will actually look when inserted into the software program (without the codes). After previewing the revised format of the note, Ann completes the note using the revised note format and a second note is sent to the active window of the clinical notes program. Satisfied, with the revised note, Ann deletes the previous note. Ann exits the edit function for night pain button 312 and resumes collecting information regarding Brian Byrnt. Ann saves her revised set of note creation tools to keep the changes to this particular note creation template by saving her toolbar.

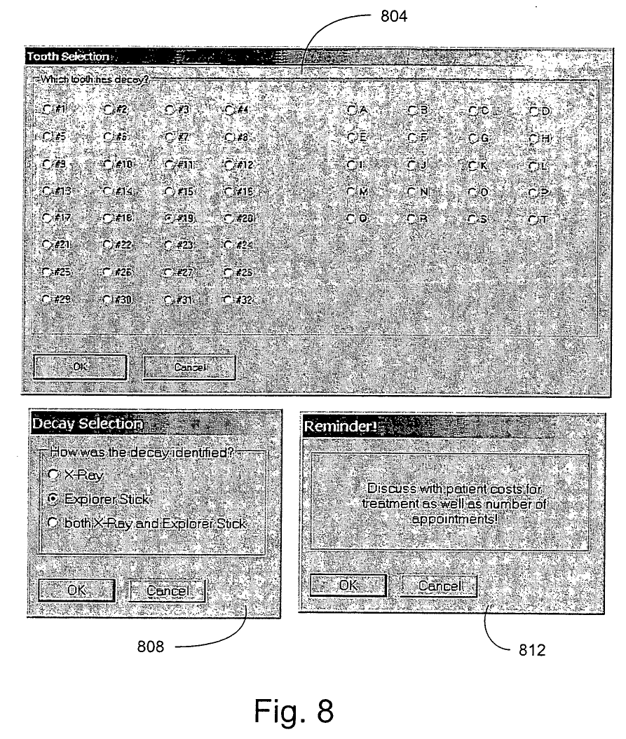

Ann now moves to a tooth decay button (not shown as it is a choice on the Diagnosis tab) to enter a note regarding tooth decay found on another tooth in Brian's mouth. After actuating the tooth decay button, Ann is presented with a series of dialog boxes (shown in FIG. 8) After indicating in the Tooth Selection dialog box 804 that it is tooth number 19, Ann indicates in Decay Selection dialog box 808 how the decay was identified. Ann then receives a reminder dialog box 812 from the tooth decay note routine to discuss specific treatment costs. After acknowledging the receipt of this instruction, the note creation software provides a series of keystrokes to the keyboard input buffer and these keystrokes are taken by the clinical note software to insert the note into the patient's record.

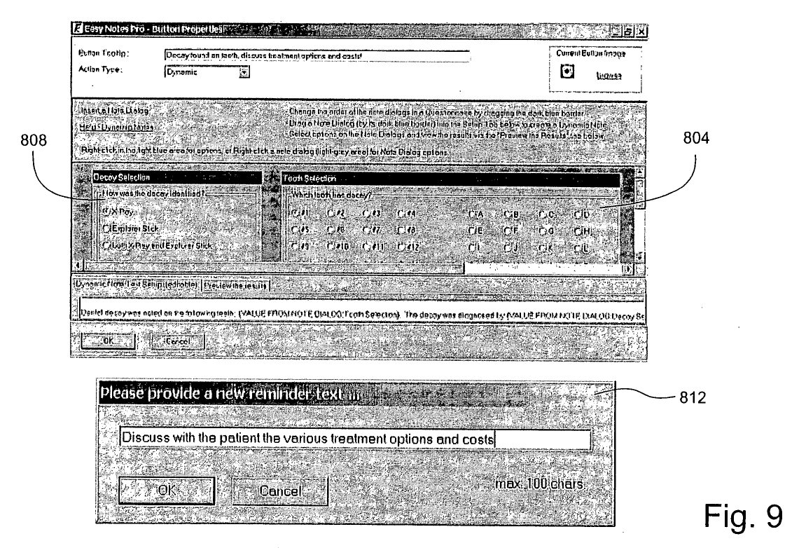

Although Ann likes the format of the note written to the clinical note software, she would prefer to indicate the diagnosis tool first, then the tooth. Ann selects the tooth decay button for editing in the same manner described above. After she drags and drops the second dialog box for decay selection 808 to the front (left) of the tooth selection dialog box 804 to alter the sequence of questions when this button routine is executed, the screen appears as is shown in FIG. 9. Note that this movement did not alter the form of the note as the note receives input from specific dialog boxes rather than first input and second input.

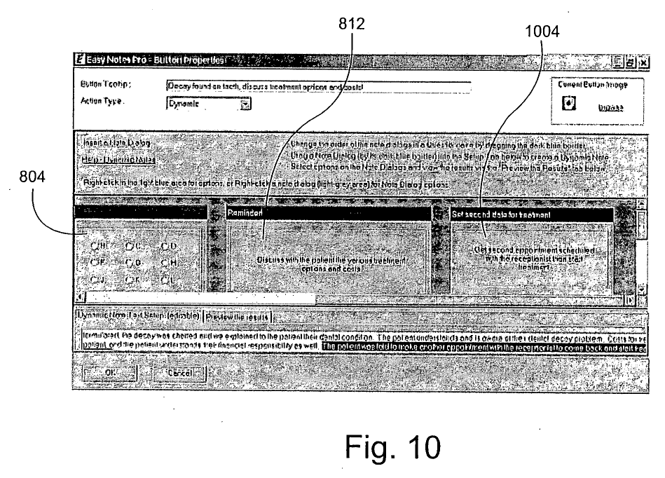

Ann moves to the third dialog box and right clicks on the reminder to alter it. Ann decides to split the reminder into two steps so that she does not skip anything when providing these instructions to the patients. First she edits the text of the current reminder dialog box 812 then adds a second reminder dialog box 1004 to provide the rest of the reminder. Now execution of this button routine will ask her the questions for input in her preferred order and then provide the reminder instructions in two steps. Note that as show in FIG. 10, the reminder text provided to the dentist does not have to be the precise text added to the note.

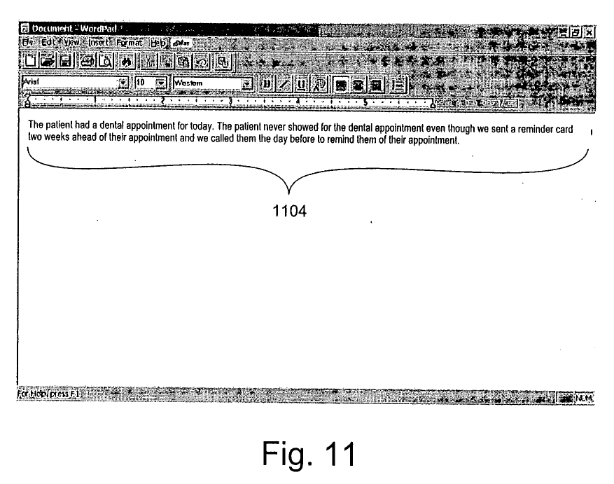

For an appointment later that day, the patient does not show up. Ann wishes to note this in the patient file. She selects the ADMIN tab (element 328 in FIG. 3) and a button (not shown) for patient did not show up for the appointment. After selecting the patient-did-not-show-up-for-appointment button, and without further input by Ann, a static note 1104 (no variables) is placed in the clinical note program as shown in FIG. 11.

Implementation notes for one implementation are as follows. The present invention can be implemented in Microsoft.NET. The toolbar can be built as a .NET assembly that exists in the form of a dll file. The toolbar is linked to the third party application by subclassing the application's window. To minimize the demands on the user to initiate the link, the invention may be implemented so that the user to indicates a desire to link to the note creation software the window with the relevant clinical note program by dropping a target cursor onto the displayed third party application. Using a documented Windows API call, the note creation software procedure is inserted before the clinical note program procedure.

In an optional feature, the note creation software can be permanently (until undone) linked to the clinical note program. One implementation of this feature is achieved by an autolistener program implemented as a TSR program (“TSR” stands for “Terminate but Stay Resident). In FIG. 3, an icon 332 for an implementation of the present invention shows as an (“E”) near the bottom right corner of the taskbar on your desktop screen. The autolistener program is loaded into the startup file of the Windows Operating System so it is started with the startup sequence of the computer. The autolistener program “listens” for the program that the note creation software has been permanently linked to. When the user launches the clinical note program, the autolistener program interprets that command and then initiates the sequence of commands to achieve the same result as manually linking the note creation software to the clinical note program thus saving the user from the extra steps to link the toolbar to the third party application each time the third party application is launched.

The invention may be implemented without the need to modify the default behavior of the third party application. The third party application continues to receive all the Windows messages without alteration. The invention may be implemented so that the note creation software does monitor the messages for the window running the clinical note program so that the linked toolbar can be minimized, maximized, restored, and closed as the window with the clinical note program is minimized, maximized, restored, and closed.

The invention may be implemented so that the note creation software creates a new note in a memory block controlled and owned by the note creation software. The toolbar with its associated tabs, buttons, and note routines note may be stored as an XML file with a signature added to prevent external tampering (editing through means other than the note creation software). The operation of a note routine causes a series of symbols to go to the Windows keyboard messaging queue (keyboard input buffer). The effect is that the clinical note program receives the keystrokes from the input buffer as if the keystrokes were manually entered by the user. The invention may be implemented so that this is performed using standard Windows APIs so that the transfer of the keystrokes is accomplished through the use of the operating system. As referenced above, the note creation software changes the active window within the computer to the window with the clinical note program so that keystrokes received in the keyboard input buffer as passed to the clinical note program.

While another implementation could make the transfer of a formatted note to the clinical note program through the clipboard program, this is may not be an ideal solution since so many programs make use of that program. If the clipboard program is used, then the note would be pasted to the textbox of the clinical note program either through passing the appropriate keystrokes sequence to the keyboard buffer or by keystrokes provided by the user after the focus has moved to the clinical note program textbox.

Some clinical note program programs have a keystroke sequence such as ALT c or ALT o to move to the end of the free formatted text field. It is only some of the clinical note program that uses these special command keystroke sequences as some other clinical note program with just a text field such as Word or WordPad does not need such a text string to access the note section of the program.

The present invention is not limited to a particular way of conveying the information from one set of software code to another set of software code. In another implementation that uses aspects of the present invention, this sequence of command keystrokes that is recognized by one set of software code as a request to move to the end of the free formatted text field is provided to the software code used to facilitate the creation of notes so that notes can be passed with a prefix of the relevant keystroke sequence to indicate input to the free formatted text field. If such as sequence is useful, then the specific sequence for that particular piece of clinical note program would need to be made known to the note creation software code either by explicitly providing the key sequence during the operation to link the computer or by the note creation software knowing the various keystroke sequences used for the commonly used clinical note programs. However passing this sequence of command keystrokes is not necessary as the user of the clinical note program that will receive the created note can move the cursor through mouse, tabs, or control characters before initiating a button's note generation sequence.

Additional Alternative Implementations

The examples given above show the movement of a note created through use of the note creation software into a window of the clinical notes program. In order to show the created note, the clinical notes program textbox was left open after the receipt of the note. Some users may prefer this option, especially as they are first using the note creation software and are gaining confidence in it. Operating in this mode, the end user can read each created note before manually closing the textbox in the clinical notes program. The end user would also be able to modify or expand the notes to capture additional detail. As the end user has the ability to alter the text of the note or to add additional buttons to the toolbar, over time it is expected that the number of edits made by the end user will decrease until it is an unusual note that needs to be edited.

Alternatively, end users may become so used to the note creation software that has evolved to capture their note writing preferences that the vast majority of notes are entered into the system without further modification by the end user. For such end users, it would be more efficient to allow an end user to complete a note generated by the routine associated with one note button and proceed directly to creating the next note based on the routine of another note button. In one implementation of the present invention the end user can set a default to either elect to leave the focus of the active window in the textbox of the clinical notes program or close the textbox and return the focus of the active window back to the note creation software toolbar so that the end user can quickly start a new note. The end user can then wait until the end of the session to open the clinical notes program and review all of the notes for that session for accuracy and completeness and make any necessary edits.

The present invention has been disclosed in the context of medical notes taken by a medical service provider. The present invention is not limited to this field and does not rely on any particular aspect of the medical service field beyond the fact that certain types of procedures or interactions are likely to happen with sufficient frequency to merit some effort to automate the process of collecting facts and recording them in a specific way. While the note creation software can be run as an external add-on for software programs provided by third parties it is obviously not precluded from running with software provided by the same entity that provided the note creation software. The only limitation is that the third party software program must be able to receive text input from the keyboard. As a practical matter, this note creation software is only going to provide value in situations where at least a subset of the notes that are collected are in a predictable format such that partial or full automation of the creation of the notes is possible.

The following table provides a small sample of other analogous situations with a skilled observer collecting information and desiring to quickly and accurately capture the facts and the context of the facts in an electronic note.

| | Observed | |
|---|---|---|
| Observer | entity | Typical transaction |
| Insurance | Damaged car | Note location and severity of various types |
| adjuster | | of damage to a car |
| Mechanic | Jet Engine | Note the specific items that were repaired, |
| | | replaced or inspected on the jet engine. |
| Biologist | Study | Quickly and accurately record details of |
| | subject | one of a number of specific types of |
| | | behavior of interest to the study. |
| System | Server | Note the details of various types of |
| Administrator | | upgrades; repairs; or failures. |
| Help Desk | Caller | Automate the process of collecting |
| | | information about various calls for |
| | | assistance. Note as the types of problems |
| | | for the callers will gradually change over |
| | | time, there is a need to update the |
| | | observation templates to address the |
| | | newest virus or software incompatibility |
| | | problem. |
| Trainer | Weightlifter | Note the relevant details regarding each |
| | | exercise including presence of pain, |
| | | changes in order of performing exercises |
| | | and other facts that would be difficult to |
| | | capture in a mere checklist form. |
| Cosmetologist | Customer | Record hair customer preferences such as |
| | | color preferences, details for hair cut |
| | | preferences; record details of services |
| | | provided such as details on the chemicals |
| | | used and time duration of application so |
| | | that the process can be replicated or |
| | | adjusted as needed in a future visit. |

The examples set forth above are given in context of Microsoft software tools as this is a well known set of tools to those of skill in the art. The scope of the invention is not limited to computers running the enumerated Microsoft tools. Those of ordinary skill in the art will find that these teachings can be ported without undue experimentation to computers running products from other suppliers or operating systems including without limitation products from Apple Computer, Inc. based in Linux or Unix, or other combinations of software as long as there is the ability to run both the note creation software and the clinical note program and there is a buffer that receives input to be placed into the active window (or analogous term in that system). The form factor of the screen shots used in this document is from a standard personal computer display. Those of ordinary skill in the art could adapt the teachings of the present invention to use on smaller, perhaps hand held devices capable of receiving and storing text input. This category of smaller devices includes but is not limited to Personal Digital Assistants (PDAs), mobile phones with additional capabilities, and small personal computer devices.

This invention may, however, be implemented in many different forms and should not be construed as limited to the examples set forth herein; rather, these examples are provided so that this disclosure will be thorough and complete, and will fully convey the scope of the invention to those skilled in the art.

Those skilled in the art will recognize that the methods and apparatus of the present invention have many applications and that the present invention is not limited to the specific examples given to promote understanding of the present invention. Moreover, the scope of the present invention covers the range of variations, modifications, and substitutes for the system components described herein, as would be known to those of skill in the art.

One of skill in the art will recognize that alternatives set forth above are not universally mutually exclusive and that in some cases alternative implementations can be created that implement at least portions of two or more of the variations described above.

The legal limitations of the scope of the claimed invention are set forth in the claims that follow and extend to cover their legal equivalents. Those unfamiliar with the legal tests for equivalency should consult a person registered to practice before the patent authority which granted this patent such as the United States Patent and Trademark Office or its counterpart.

What is claimed is:

1. A method for creating a note regarding a transaction for storage via a software program, the method comprising:
opening a first set of note creation templates;
editing the first set of note creation templates to create a second set of note creation templates;
saving the second set of note creation templates with an identifier such that a subsequent effort to create a note includes the option of selecting to use the second set of note creation templates from a set of choices including the first set of note creation templates and the second set of note creation templates; and
using the second set of note creation templates in a process of creating a note regarding a transaction and then storing the note through use of the software program.

2. The method of creating a note of claim 1 wherein the subsequent effort to create a note includes the option of selecting a set of note creation templates customized for use by a first type of user and the option of selecting a set of note creation templates customized for use by a second type of user.

3. The method of creating a note of claim 2 wherein the subsequent effort to create a note includes the option of selecting a different set of note creation templates customized for use by a dentist and the option of selection a set of note creation templates customized for use by a dental hygienist.

4. The method of creating a note of claim 1 wherein the subsequent effort to create a note includes the option of selecting a set of note creation templates customized for use in creating notes regarding a first type of patient and the option of selection a different set of note creation templates customized for creating notes regarding a second type of patient.

5. The method of creating a note of claim 1 wherein the user navigates through a set of note creation templates through a toolbar user interface.

6. The method of creating a note of claim 1 wherein the note concerns an interaction between a health care provider and a patient and the note is stored as part of a set of electronic records for that patient.

7. A method for creating a note regarding a transaction for storage via a software program, the method comprising:
selecting a note creation template choice from a set of note creation template choices;
selecting a first value from a limited set of at least two choices
creating a note that combines binder text associated with the selected note creation template and the selected first value; and
causing the storage of the created note.

8. The method of claim 7 wherein causing the storage of the note is initiated by selecting the first value from one of the limited set of at least two choices.

9. The method of claim 7 wherein the step of selecting a first value from a limited set of at least two choices is followed by selecting a second value from a limited set of at least two choices and the step of creating a note, creates a note that combines binder text associated with the selected note creation template and both the selected first value and the selected second value and the step of causing the storage of the note is initiated by completing the selection of a value beyond the first value.

10. A method for creating a note regarding a transaction for storage via a software program the method comprising:
determining that an aspect of a current transaction needs to be recorded to storage via the software program;
selecting a note creation template choice from a set of note creation template choices;
viewing a set of context providing binder text for the selected note creation template;
altering the context providing binder text;
saving the context providing binder text as a revised aspect of the set of note creation template choices;
selecting a value from one of a limited set of at least two choices;
creating a note that includes the revised context providing binder text and the selected value; and
causing the storage of the created note.

11. The method of claim 10 wherein the saving of the context providing binder text as a revised aspect of the set of note creation template choices causes the storage of a new set of note creation template choices while retaining an option for a user to access a set of note creation template choices that still has the unaltered context providing binder text.

12. The method of claim 10 wherein the saving of the context providing binder text precedes the selecting a value from one of a limited set of at least two choices.

13. The method of claim 10 wherein the saving of the context providing binder text is performed after causing the storage of the created note.

14. A method for creating a note regarding a transaction for storage via a software program, the method comprising:
determining that an aspect of a current transaction needs to be recorded to storage via the software program;
selecting a note creation template choice from a set of note creation template choices, the selected note creation template adapted for displaying a request for a first value selection for receiving a first input before showing a request for a second value selection for receiving a second input;
editing the order of display of the requests for a first and second value selection that appear during execution of the selected note creation template so that the first request for a first value is displayed after the second request for a second value;
saving the edited note creation template;
executing the edited note creation template;
providing a response to the second request for a second value before responding to the first request for a first value;
creating a note including binder text associated with the selected note creation template and both the first value and the second value such that the first value appears before the second value as determined by a conventional order for reading text;
causing the storage of the note.

15. The method of claim 14 wherein editing the order of requests for the first vale and for the second value that are displayed during execution of the selected note creation template does not alter the particular order of the request for the first value and for the second value in the created note.

16. A method for creating a note regarding a transaction for storage via a software program, the method comprising:
determining that an aspect of a current transaction needs to be recorded to storage via the software program;
selecting a note creation template choice from a set of note creation template choices;
editing a displayed reminder to alter a set of reminder text that is provided to a display screen;
saving the edited note creation template;
executing the edited note creation template;
viewing the altered set of reminder text;
acknowledging receipt of the altered set of reminder text;
causing the storage of a note through the software program wherein the note indicates the acknowledgement of receipt of the reminder text.

17. The method of claim 16 wherein the text used in the stored note indicating the acknowledgement of the reminder text is not automatically altered during the editing of the displayed reminder text.

18. Machine readable media containing note creation software for creating and storing a note about a transaction, the note creation software adapted to allow an end user to:
open a first set of note creation templates while operating the note creation software;
edit the first set of note creation templates to create a second set of note creation templates;
save the second set of note creation templates with an identifier such that subsequent use of the note creation software includes the option of selecting to use the second set of note creation templates from a set of choices including the first set of note creation templates and the second set of note creation templates; and
use the second set of note creation templates in a process of creating a note regarding a transaction and then storing the note through the use of the note creation software.

19. Machine readable media containing note creation software for creating and storing a note about a transaction, the note creation software adapted to allow an end user that has determined that an aspect of a current transaction needs to be recorded to storage via the software program to:
select a note creation template choice from a set of note creation templates;
view a set of context providing binder text for the selected note creation template;
alter the context providing binder text;
save the context providing binder text as a revised aspect of the set of note creation templates;
respond to a request to select one of a limited set of at least two choices; and
cause the storage of a note through the software program wherein the note includes the selected choice and the altered context providing binder text.
